(19) United States
(12) Patent Application Publication
(10) Pub. No.: US 2026/0080840 A1
(43) Pub. Date: Mar. 19, 2026

(54) DRIVING METHOD FOR DISPLAY DEVICE

(71) Applicant: InnoLux Corporation, Miao-Li County (TW)

(72) Inventors: Yu-Hsin FENG, Miao-Li County (TW); Chan-Feng CHIU, Miao-Li County (TW); Di WU, Miao-Li County (TW); Wei-Sin CHANG, Miao-Li County (TW)

(21) Appl. No.: 19/301,307

(22) Filed: Aug. 15, 2025

Related U.S. Application Data
(60) Provisional application No. 63/694,976, filed on Sep. 16, 2024.

(30) Foreign Application Priority Data
May 20, 2025 (CN) 202510648093.7

(51) Int. Cl. G09G 3/34

(52) U.S. Cl. CPC G09G 3/3426; G09G 2300/0426; G09G 2310/027; G09G 2330/021

(57) ABSTRACT

A driving method for a display device, which has sub-pixels, scan lines and data lines, includes the steps of: receiving a frame data including multiple sub-pixel grayscale values corresponding to the sub-pixels; calculating an absolute difference value between a first sub-pixel grayscale value and a second sub-pixel grayscale value, wherein the first sub-pixel is electrically connected with a data line and one of two scan lines, the second sub-pixel is electrically connected with the data line and the other one of the two scan lines; and, when the absolute difference value is greater than or equal to a first threshold, adjusting at least one of the sub-pixel grayscale values of the first and second sub-pixels, wherein an absolute difference value between the adjusted sub-pixel grayscale values of the first and second sub-pixels is smaller than the absolute difference value between the first and second sub-pixel grayscale values.

### CROSS-REFERENCE TO RELATED APPLICATIONS

This application claims the benefit of filing date of U.S. Provisional Application Ser. No. 63/694,976 filed on Sep. 16, 2024 under 35 USC § 119(e)(1), and also claims the benefit of the Chinese Patent Application Serial Number 202510648093.7, filed on May 20, 2025, the subject matters of which are incorporated herein by reference.

### BACKGROUND

### Field of the Disclosure

The present disclosure relates to a driving method and, more particularly, to a driving method for a display device.

### Description of Related Art

The power consumed by current display devices when displaying a critical image is much higher than the power consumed when displaying a normal image. For example, the power consumed when displaying a normal image is about 20% of the power consumed when displaying a critical image. Therefore, a critical image will increase the design cost of the power supply of the display device and limit the application range of portable display devices.

Therefore, it is desired to provide a novel driving method for a display device to alleviate and/or obviate the above problems.

### SUMMARY

The present disclosure provides a driving method for a display device.

The display device includes a plurality of scan lines, a plurality of data lines and a plurality of sub-pixels. Each of the plurality of data lines is electrically connected to a portion of the plurality of sub-pixels, and each of the plurality of sub-pixels in the portion is electrically connected to one of the plurality of scan lines. The driving method includes the steps of: receiving a frame data including a plurality of sub-pixel grayscale values corresponding to the plurality of sub-pixels; calculating an absolute difference value between a first sub-pixel grayscale value and a second sub-pixel grayscale value respectively corresponding to a first sub-pixel and a second sub-pixel respectively electrically connected to one of the plurality of data lines and two of the plurality of scan lines; and comparing the absolute difference value between the first sub-pixel grayscale value and the second sub-pixel grayscale value with a first threshold value and, when the absolute difference value is greater than or equal to the first threshold value, adjusting the sub-pixel grayscale value of at least one of the first sub-pixel and the second sub-pixel, wherein an absolute difference value between the sub-pixel grayscale values of the first sub-pixel and the second sub-pixel after adjustment is smaller than an absolute difference value between the first sub-pixel grayscale value and the second sub-pixel grayscale value.

Other novel features of the disclosure will become more apparent from the following detailed description when taken in conjunction with the accompanying drawings.

### BRIEF DESCRIPTION OF DRAWINGS

FIG. 1 is a schematic diagram of a display device according to an embodiment of the present disclosure;

FIG. 2A is a schematic diagram of the frame data corresponding to the sub-pixels of one embodiment of the present disclosure;

FIG. 2B is a schematic diagram of the frame data corresponding to the sub-pixels of another embodiment of the present disclosure;

FIG. 3 is a schematic diagram illustrating the steps of the driving method according to an embodiment of the present disclosure;

FIG. 4 schematically illustrates the steps of the driving method according to another embodiment of the present disclosure;

FIG. 5 is a schematic diagram of the voltage supply time adjustment according to an embodiment of the present disclosure;

FIG. 6 is a schematic diagram of the slew rate adjustment according to an embodiment of the present disclosure; and

FIG. 7 is a schematic diagram of the gamma curve adjustment according to an embodiment of the present disclosure.

### DETAILED DESCRIPTION OF EMBODIMENT

Reference will now be made in detail to exemplary embodiments of the present disclosure, examples of which are illustrated in the accompanying drawings. Wherever possible, the same reference numerals are used in the drawings and description to refer to the same or like parts.

Throughout the specification and the appended claims, certain terms may be used to refer to specific components. Those skilled in the art will understand that electronic device manufacturers may refer to the same components by different names. The present disclosure does not intend to distinguish between components that have the same function but have different names. In the following description and claims, words such as “containing” and “comprising” are open-ended words, and should be interpreted as meaning “including but not limited to”.

The terms, such as “about”, “substantially”, or “approximately” are generally interpreted as within 10% of a given value or range, or as within 5%, 3%, 2%, 1% or 0.5% of a given value or range.

In the specification and claims, unless otherwise specified, ordinal numbers, such as “first” and “second”, used herein are intended to distinguish components rather than disclose explicitly or implicitly that names of the components bear the wording of the ordinal numbers. The ordinal numbers do not imply what order a component and another component are in terms of space, time or steps of a manufacturing method. Thus, what is referred to as a “first component” in the specification may be referred to as a “second component” in the claims.

In the present disclosure, the terms “the given range is from the first numerical value to the second numerical value” and “the given range falls within the range from the first numerical value to the second numerical value” mean that the given range includes the first numerical value, the second numerical value, and other numerical values therebetween.

In addition, the display device of the present disclosure may be integrated into an electronic device, and the electronic device may include an automation device, a clamping device, a computing device, a mechanical device, a drug preparation device, an exposure device, a printing device, a three-dimensional printing device, a vehicle device, an imaging device, an assembly device, a backlight device, an antenna device, a tiled device, a touch electronic device, a curved electronic device, or a free shape electronic device, but not limited thereto. The display device may, for example, include a liquid crystal, a light emitting diode, fluorescence, phosphorescence, other suitable display media, or a combination thereof, but not limited thereto. The display device may be a non-self-luminous display device or a self-luminous display device. The antenna device may be a liquid crystal antenna device or a non-liquid crystal antenna device, and the sensing device may be a sensing device for sensing capacitance, light, heat, or ultrasound, but not limited thereto. The tiled device may, for example, include a display tiled device or an antenna tiled device, but not limited thereto. It should be noted that the electronic device may be any combination of the above, but not limited thereto. In addition, the electronic device may be a bendable or flexible electronic device. It should be noted that the electronic device may be any combination of the above, but not limited thereto. In addition, the appearance of the electronic device may be rectangular, circular, polygonal, a shape with curved edges or other suitable shapes. The electronic device may have peripheral systems such as a drive system, a control system, a light source system, a shelf system, etc. to support the display device, the antenna device or the tiled device.

The electrical connections described in the present disclosure may refer to direct connections or indirect connections. In the case of direct connections, the endpoints of the components on the two circuits are directly connected or interconnected by a conductor segment, and in the case of indirect connections, there is a switch, a diode, a capacitor, an inductor, other suitable components, or a combination of the above components disposed between the endpoints of the components on the two circuits, but not limited to the combination of these components.

It is noted that the following are exemplary embodiments of the present disclosure, but the present disclosure is not limited thereto, while a feature of some embodiments can be applied to other embodiments through suitable modification, substitution, combination, or separation. In addition, the present disclosure can be combined with other known structures to form further embodiments.

Unless otherwise defined, all terms (including technical and scientific terms) used herein have the same meaning as commonly understood by those skilled in the art related to the present disclosure. It can be understood that these terms, such as those defined in commonly used dictionaries, should be interpreted as having meaning consistent with the relevant technology and the background or context of the present disclosure, and should not be interpreted in an idealized or excessively formal way. Unless there is a special definition in the embodiment of the present disclosure.

In addition, the term “adjacent” in the specification and claims is used to describe two objects that are adjacent to each other. The two adjacent objects may be in contact or not in contact, but there are no other objects of the same type between the two adjacent objects.

In addition, the description of “when . . . ” or “while . . . ” in the present disclosure means “now, before, or after”, etc., and is not limited to occurrence at the same time. In the present disclosure, the similar description of “disposed on” or the like refers to the corresponding positional relationship between the two elements, and does not limit whether there is contact between the two elements, unless specifically limited. Furthermore, when the present disclosure recites multiple effects, if the word “or” is used between the effects, it means that the effects can exist independently, but it does not exclude that multiple effects can exist at the same time

The semiconductor chip of the present disclosure has a special structure. Compared with the prior art, it is more suitable to be assembled to a specified position on a substrate using a fluid assembly method to form a semiconductor device. First, the structure of the semiconductor chip is described. In addition, to make the description clearer, the directions in the figure will be defined as X direction, Y direction and Z direction, where the X direction may be, for example, the extension direction of the scan line, the Y direction may be, for example, the extension direction of the data line, and the Z direction may be, for example, the top view direction of the display device.

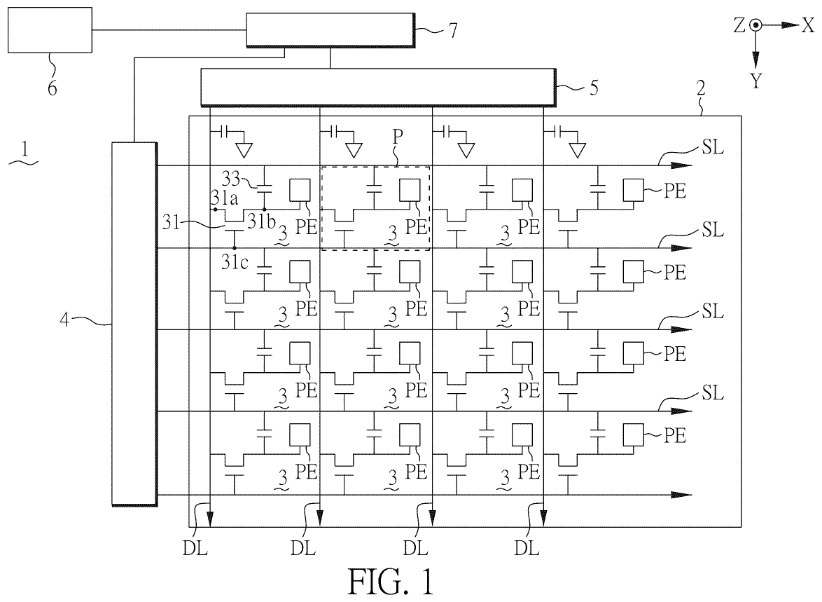

FIG. 1 is a schematic diagram of a display device 1 according to an embodiment of the present disclosure. As shown in FIG. 1, the display device 1 includes a plurality of scan lines SL, a plurality of data lines DL, and a plurality of sub-pixels P. In one embodiment, a sub-pixel P may be defined by two adjacent scan lines SL and two adjacent data lines DL, and each sub-pixel includes a sub-pixel electrode PE. In one embodiment, the plurality of scan lines SL, data lines DL, and sub-pixel electrodes PE may be disposed on a substrate 2. The plurality of scan lines SL may each extend along the X direction and be arranged in sequence in the Y direction, the plurality of data lines DL may each extend along the Y direction and be arranged in sequence in the X direction, and the plurality of scan lines SL and the plurality of data lines DL may be staggered to form the plurality of sub-pixels P, while it is not limited thereto. Each of the data lines DL is electrically connected to a portion of the sub-pixels P, and each of the sub-pixels P of the portion is electrically connected to one of the scan lines SL. In detail, each of the data lines DL is electrically connected to the sub-pixel electrodes PE in a portion of the sub-pixels P, and each of the sub-pixel electrodes PE in the portion of the sub-pixels P is electrically connected to one of the scan lines SL.

In one embodiment, the plurality of scan lines SL may be electrically connected to at least one gate driver 4, and the gate driver 4 may transmit a gate signal to the sub-pixels P through the scan line SL. The plurality of data lines DL may be electrically connected to at least one data driver 5. The data driver 5 may transmit a data signal to one of the sub-pixels P through the data line DL, wherein the data signal may include a grayscale signal. In general, when the sub-pixel P receives sufficient grayscale signal, the grayscale value displayed by the sub-pixel P may correspond to the voltage peak value of the grayscale signal, while it is not limited thereto. In the same time interval, all sub-pixels P may display corresponding grayscale values according to the received grayscale signals, thereby displaying a display frame, wherein the content of the display frame may correspond to a frame data. In more detail, an external image source (not shown) may provide a frame data, the data driver 5 may provide corresponding data signal to each sub-pixel P according to the content of the frame data, and each sub-pixel P may display corresponding grayscale value according to the received data signal, thereby displaying the display frame, while it is not limited thereto. In one embodiment, the frame data may include a plurality of sub-pixel grayscale values corresponding to the plurality of sub-pixels P, respectively. In addition, the gate driver 4 and/or the data driver 5 may be disposed on the substrate 2, but may also be disposed outside the substrate 2. In one embodiment, the gate driver 4 and/or the data driver 5 may be electrically connected to a timing controller 7, and the timing controller 7 may drive the gate driver 4 and/or the data driver 5. For the convenience of explanation, the frame data provided by the external image source will be referred to as the original frame data hereinafter.

The sub-pixel P may have multiple types, such as a sub-pixel corresponding to red, a sub-pixel corresponding to blue, and a sub-pixel corresponding to green, while it is not limited thereto. In one embodiment, each sub-pixel P may include a switch element 31, a sub-pixel electrode PE, and/or a storage capacitor 33 electrically connected to each other. The sub-pixel P may include, for example, a liquid crystal layer or a light-emitting layer, while it is not limited thereto. In addition, for each switch element 31, its first end 31a may be electrically connected to one of the data lines DL, its second end 31b may be electrically connected to one of the sub-pixel electrodes PE and/or the storage capacitor 33, and its control end 31c may be electrically connected to one of the scan lines SL.

Since the plurality of sub-pixels P are arranged in an array form, all sub-pixel electrodes PE may be arranged to have a plurality of rows (X direction) and a plurality of columns (Y direction), wherein the sub-pixel electrodes PE in the same row may be electrically connected to the same scan line SL through different switch elements 31, and the sub-pixel electrodes PE in the same column may be electrically connected to the same or different data lines DL through different switch elements 31, while it is not limited thereto.

In one embodiment, the display device 1 may further include a processing unit 6, for example, the processing unit 6 may be disposed inside the display device 1, or the display device 1 may not include the processing unit 6, for example, the processing unit 6 may be disposed outside the display device 1, and the processing unit 6 and the data driver 5 may be electrically connected or communicated with each other to transmit signals. In one embodiment, the processing unit 6 may be used to execute a calculation procedure for calculating the absolute difference value between two sub-pixel grayscale values. The processing unit 6 may be used to execute a comparison procedure for comparing the absolute difference value with a first threshold value, and determining whether at least one of the two sub-pixel grayscale values needs to be adjusted according to the comparison result. In one embodiment, the processing unit 6 may be hardware, for example, including a microprocessor, a chip, a controller, a circuit or similar components, while it is not limited thereto. In one embodiment, the processing unit 6 may be a functional module, which may realize its function by executing at least one instruction in at least one computer program product stored in at least one non-transitory computer-readable medium by a processor, a chip or a controller, while it is not limited thereto. In one embodiment, the original frame data provided by the external image source (not shown) may be first transmitted to the processing unit 6 for processing and then transmitted from the processing unit 6 to the timing controller 7, and the timing controller 7 drives the data driver 5 according to the processed frame data, while it is not limited thereto.

The features of the present disclosure may include, for example, that, after receiving the original frame data, the processing unit 6 may determine whether a sub-pixel grayscale value in the original frame data needs to be adjusted (for example, determining whether the sub-pixel grayscale value is a critical factor for forming a critical image), and may provide an adjustment scheme. However, the features of the present disclosure are not limited thereto.

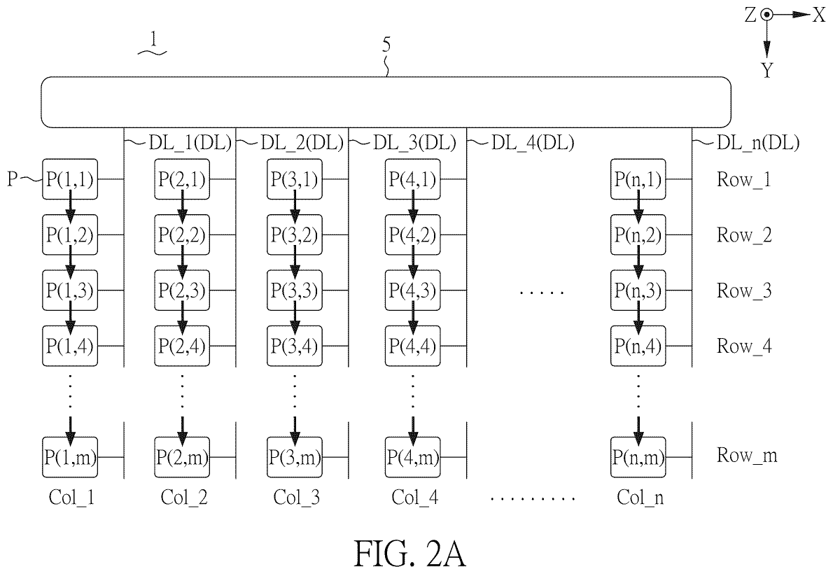

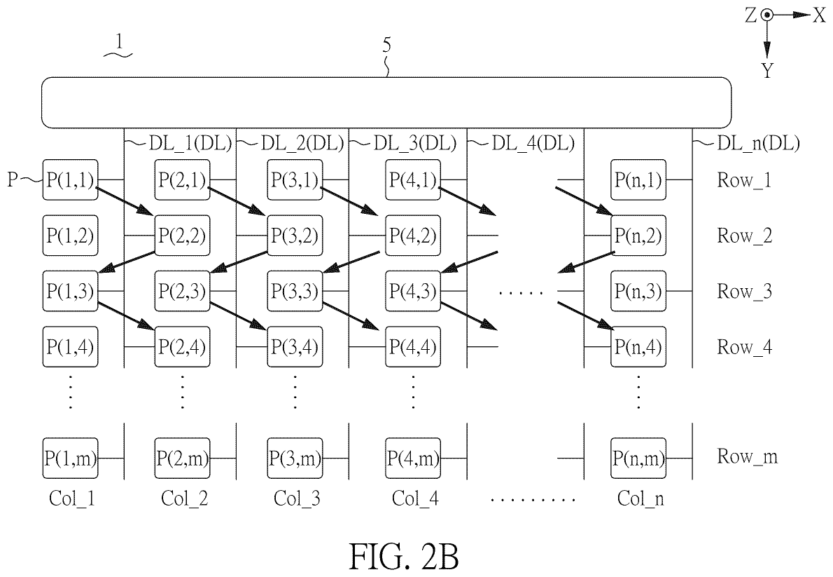

Next, the part in which the processing unit 6 detects the original frame data is described. Please refer to FIG. 2A, FIG. 2B and FIG. 3, as well as FIG. 1 for assistance, wherein FIG. 2A is a schematic diagram of the frame data corresponding to the sub-pixels P of one embodiment of the present disclosure, FIG. 2B is a schematic diagram of the frame data corresponding to the sub-pixels P of another embodiment of the present disclosure, and FIG. 3 is a schematic diagram illustrating the steps of the driving method according to an embodiment of the present disclosure. It should be noted that, in order to make the important features clearer, FIG. 2A and FIG. 2B only show the sub-pixels P, the data lines DL and the data driver 5.

FIG. 2A is provided to show a configuration of sub-pixels P and data lines DL. In FIG. 2A, the display device 1 may have n data lines DL_1 to DL_n, and each data line may be electrically connected to m sub-pixels P, so that the display device 1 may have a total of m×n sub-pixels P, where m and n are each a positive integer. The m×n sub-pixels P may be arranged into n columns Col_1 to Col_n and m rows Row_1 to Row_m, where the sub-pixels P in the same column may be electrically connected to the same data line DL, and the sub-pixels P in the same row may be regarded as being electrically connected to the same scan line SL (please refer to FIG. 1). For example, the sub-pixels (P(1,1), P(1,2), P(1,3), . . . , P(1,m)) in column Col_1 are all electrically connected to data line DL_1, the sub-pixels (P(2,1), P(2,2), P(2,3), . . . , P(2,m)) in column Col_2 are all electrically connected to data line DL_2, the sub-pixels (P(3,1), P(3,2), P(3,3), . . . , P(3,m)) in column Col_3 are all electrically connected to data line DL_3, and so on. In FIG. 2A, when a display frame is displayed, if the sub-pixel grayscale values corresponding to the sub-pixels P in the odd rows (Row_1, Row_3, . . . ) are all the minimum or maximum grayscale values (for example, 0 or 255), and the sub-pixel grayscale values corresponding to the sub-pixels P in the even rows (Row_2, Row_4, . . . ) are all the maximum or minimum grayscale values (for example, 255 or 0), the display frame displayed by the display device 1 at this moment may be regarded as a critical image, and will cause a sharp increase in the power consumption of the display device 1. In other words, in view of the data line DL_1, the sub-pixel grayscale values received thereby will be alternately switched between the maximum grayscale value and the minimum grayscale value, so that the corresponding display frame is regarded as a critical image.

FIG. 2B is provided to show another configuration of sub-pixels P and data lines DL. Since some features of FIG. 2B are applicable to the description of FIG. 2A, the following description mainly focuses on the differences. In FIG. 2B, sub-pixels P in the same column may be electrically connected to different data lines DL. For example, the sub-pixels (P(1,1), P(1,3), . . . ) in the column Col_1 and the sub-pixels (P(2,2), P(2,4), . . . ) in the adjacent column Col_2 may be electrically connected to the data line DL_1, the sub-pixels (P(2,1), P(2,3), . . . ) in the column Col_2 and the sub-pixels (P(3,2), P(3,4), . . . ) in the adjacent column Col_3 may be electrically connected to the data line DL_2, the sub-pixels (P(3,1), P(3,3), . . . ) in the column Col_3 and the sub-pixels (P(4,2), P(4,4), . . . ) in the adjacent column Col_4 may be electrically connected to the data line DL_3, and so on. In FIG. 2B, when a display frame is displayed, if the sub-pixel grayscale values corresponding to the sub-pixels P in the odd rows (Row_1, Row_3, . . . ) are all the minimum or maximum grayscale values (for example, 0 or 255), and the sub-pixel grayscale values corresponding to the sub-pixels P in the even rows (Row_2, Row_4, . . . ) are all the maximum or minimum grayscale values (for example, 255 or 0), the display frame displayed by the display device 1 may be regarded as a critical image, which will cause a sharp increase in the power consumption of the display device 1. Alternatively, when the sub-pixel grayscale values corresponding to the sub-pixels P in the odd columns (Col_1, Col_3, . . . ) are all the minimum or maximum grayscale values (for example, 0 or 255), and the sub-pixel grayscale values corresponding to the sub-pixels P in the even columns (Col_2, Col_4, . . . ) are all the maximum or minimum grayscale values (for example, 255 or 0), the display frame displayed by the display device 1 may be regarded as a critical image, which will cause a sharp increase in the power consumption of the display device 1.

The driving method of the display device 1 of FIG. 3 may reduce the probability of the display device 1 displaying a critical image. The driving method of FIG. 3 may be executed by at least, for example, the processing unit 6 in conjunction with the timing controller 7 and the data driver 5, but it is not limited thereto.

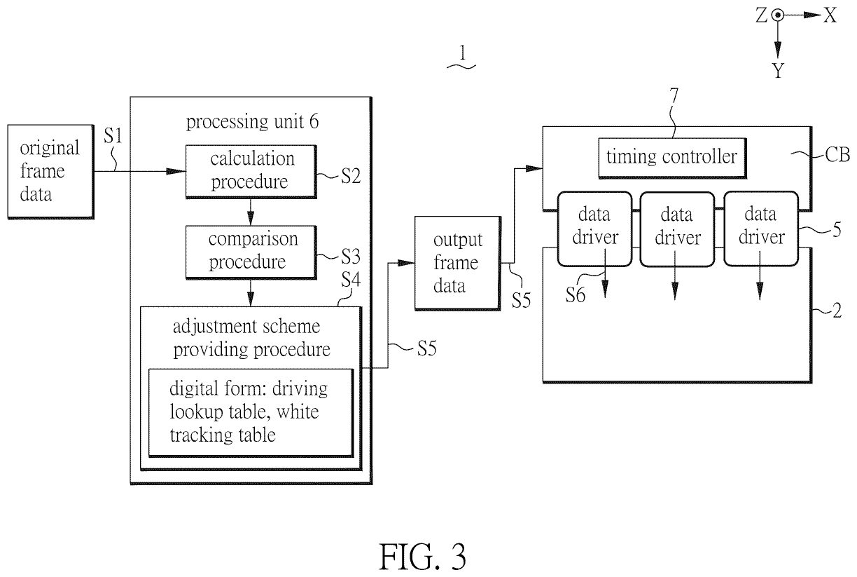

As shown in FIG. 3, step S1 is first executed, in which the processing unit 6 receives original frame data provided by an external image source (not shown), wherein the original frame data includes a plurality of sub-pixel grayscale values corresponding to a plurality of sub-pixels P. Then, step S2 is executed, in which the processing unit 6 executes a calculation procedure to calculate an absolute difference value between a first sub-pixel grayscale value and a second sub-pixel grayscale value among the plurality of sub-pixel grayscale values of the original frame data, wherein the first sub-pixel grayscale value corresponds to a first sub-pixel of the display device 1, and the second sub-pixel grayscale value corresponds to a second sub-pixel of the display device 1, and the first sub-pixel grayscale value is, for example, a sub-pixel grayscale value currently detected, and the second sub-pixel grayscale value is, for example, a sub-pixel grayscale value to be compared with the sub-pixel grayscale value currently detected. Then, step S3 is executed, in which the processing unit 6 executes a comparison procedure to compare the absolute difference value with a first threshold value. Next, step S4 is executed, in which the processing unit 6 executes an adjustment scheme providing procedure, wherein the processing unit 6 provides an adjustment scheme for the first sub-pixel grayscale value and/or the second sub-pixel grayscale value. For example, when the comparison result of the absolute difference value and the first threshold value meets a predetermined condition (for example, at least when the absolute difference value is greater than or equal to the first threshold value), the display device 1 may adjust at least one of the first sub-pixel grayscale value and the second sub-pixel grayscale value to an adjusted sub-pixel grayscale value for display according to the adjustment scheme (that is, the adjustment scheme may include both the first sub-pixel grayscale value and the second sub-pixel grayscale value being adjusted, or one of the first sub-pixel grayscale value and the second sub-pixel grayscale value being adjusted, etc.). In more detail, for example, the processing unit 6 may find an adjusted sub-pixel grayscale value corresponding to the sub-pixel grayscale value that needs to be adjusted. At this moment, the adjustment scheme may include information of the adjusted sub-pixel grayscale value, and then the data driver 5 may provide a corresponding grayscale signal to the sub-pixel P according to the adjusted sub-pixel grayscale value (such as the digital adjustment scheme described in the subsequent paragraphs), or the processing unit 6 may find a suitable driving method for the data driver 5. At this moment, the adjustment scheme may include information of the driving method to enable the timing controller 7 to control the data driver 5 according to the information of the driving method, so that the data driver 5 may actually display the adjusted grayscale value of the sub-pixel P when providing a grayscale signal corresponding to the grayscale value in the original data frame (such as the analog adjustment scheme described in the subsequent paragraphs, the details of which may be referred to the description of FIG. 4). On the contrary, if the comparison result does not meet the predetermined condition, the adjustment scheme may include an instruction to maintain the first sub-pixel grayscale value and the second sub-pixel grayscale value. In one embodiment, only one of the first sub-pixel grayscale value and the second sub-pixel grayscale value is adjusted to the adjusted sub-pixel grayscale value. Therefore, the absolute difference value between the sub-pixel grayscale values of the first sub-pixel and the second sub-pixel after adjustment (for example, the absolute difference value between the adjusted sub-pixel grayscale value and the unadjusted one of the first sub-pixel grayscale value and the second sub-pixel grayscale value) is smaller than the absolute difference value between the first sub-pixel grayscale value and the second sub-pixel grayscale value. That is, after adjustment, the absolute difference value between the sub-pixel grayscale values of the first sub-pixel and the second sub-pixel may be reduced. Therefore, the two sub-pixel grayscale values may reduce the probability of generating critical factors for forming a critical image. In another embodiment, the first sub-pixel grayscale value and the second sub-pixel grayscale value are adjusted to the first adjusted sub-pixel grayscale value and the second adjusted sub-pixel grayscale value, so that the absolute difference values between the sub-pixel grayscale values of the first sub-pixel and the second sub-pixel after the adjustment (for example, the absolute difference values between the first adjusted sub-pixel grayscale value and the second adjusted sub-pixel grayscale value) is smaller than the absolute difference value between the first sub-pixel grayscale value and the second sub-pixel grayscale value, thereby reducing the probability of generating critical factors for forming the critical image. Then, steps S2 to S4 are performed repeatedly until the adjustment scheme of a portion or all of the sub-pixel grayscale values in the original frame data is provided. Then, step S5 is performed, in which the processing unit 6 transmits an output frame data to the timing controller 7 disposed on a circuit board CB. The timing controller 7 may convert the format of the output frame data and transmit the same to the data driver 5, or the timing controller 7 may control the data driver 5 according to the output frame data, wherein the output frame data may include the adjustment scheme of each sub-pixel grayscale value, but it is not limited thereto. The data driver 5 is electrically connected to the circuit board CB to receive the signal transmitted by the timing controller 7. Then, step S6 is executed, in which the data driver 5 provides a data signal (such as a grayscale signal) to each sub-pixel P according to the output frame data. As a result, the sub-pixel grayscale value belonging to the critical factor in the original frame data may be adjusted to the adjusted sub-pixel grayscale value, so that the absolute difference value corresponding thereto may be reduced, thereby reducing the probability of the display device 1 displaying a critical image.

Regarding step S1, in one embodiment, an external image source that provides original frame data is provided. The external image source may be, for example, various image transmission lines, data transmission interfaces, or communication interfaces, but it is not limited thereto.

Next, step S2 (calculation procedure) is described. In step S2, the first sub-pixel is defined as a sub-pixel electrically connected to one of the plurality of data lines DL (hereinafter referred to as the first data line) and one of the two of the plurality of scan lines SL (hereinafter referred to as the first scan line) of the display device 1, and the second sub-pixel is defined as a sub-pixel electrically connected to the first data line and the other one of the two of the plurality of scan lines SL (hereinafter referred to as the second scan line). That is, the first sub-pixel and the second sub-pixel may be electrically connected to the same data line DL and electrically connected to different scan lines SL. Next, the first sub-pixel and the second sub-pixel are described using an example.

In one embodiment, the two of the plurality of scan lines SL (that is, the first scan line and the second scan line) may be adjacent to each other. By taking FIG. 2A as an example, each row Row_1˜Row_m may correspond to a scan line SL. When the first sub-pixel currently detected is, for example, the sub-pixel P(1,2) on the row Row_2, the second sub-pixel may be, for example, the sub-pixel P(1,1) on the adjacent row Row_1 or the sub-pixel P(1,3) on the adjacent row Row_3. At this moment, the absolute difference value may be an absolute difference value between the sub-pixel grayscale value corresponding to the sub-pixel P(1,2) and the sub-pixel grayscale value corresponding to the sub-pixel P(1,1) or the sub-pixel P(1,3), while the detection manners of other sub-pixels may be deduced in the same way. By taking FIG. 2B as an example, each row Row_1˜Row_m may correspond to a scan line. When the first sub-pixel currently detected is, for example, the sub-pixel P(2,2) in the row Row_2, the second sub-pixel may be, for example, the sub-pixel P(1,1) in the adjacent row Row_1, or the sub-pixel P(1,3) in another adjacent row Row_3. Therefore, the absolute difference value may be an absolute difference value between the sub-pixel grayscale value corresponding to the sub-pixel P(2,2) and the sub-pixel grayscale value corresponding to the sub-pixel P(1,1) or the sub-pixel P(1,3), and so on.

In another embodiment, the two of the plurality of scan lines SL (the first scan line and the second scan line) may not be adjacent to each other. By taking FIG. 2A as an example, each row Row_1˜Row_m may correspond to a scan line. The first sub-pixel may be, for example, a sub-pixel P(1,3) electrically connected to the data line DL_1 and belonging to the row Row_3, and the second sub-pixel may be, for example, a sub-pixel (for example, P(1,1)) electrically connected to the data line DL_1 and belonging to a non-adjacent row (for example, Row_1), so that the absolute difference value between the first sub-pixel grayscale value and the second sub-pixel grayscale value may be calculated, and so on. By taking FIG. 2B as an example, each row Row_1˜Row_m may correspond to a scan line. The first sub-pixel may be, for example, the sub-pixel P(1,3) electrically connected to the data line DL_1 and belonging to the row Row_3, and the second sub-pixel may be, for example, the sub-pixel (P(1,1)) electrically connected to the data line DL_1 and belonging to a non-adjacent row (for example Row_1), so that the absolute difference value between the first sub-pixel grayscale value and the second sub-pixel grayscale value may be calculated, and so on.

In addition, the calculation procedure (step S2) may further include more sub-steps. In one embodiment, the calculation procedure may include sub-steps: calculating an absolute difference value between a third sub-pixel grayscale value and a fourth sub-pixel grayscale value (hereinafter referred to as a second absolute difference value), and calculating an absolute difference value between a fifth sub-pixel grayscale value and a sixth sub-pixel grayscale value (hereinafter referred to as a third absolute difference value), wherein the third sub-pixel grayscale value corresponds to a third sub-pixel, the fourth sub-pixel grayscale value corresponds to a fourth sub-pixel, the fifth sub-pixel grayscale value corresponds to a fifth sub-pixel, and the sixth sub-pixel grayscale value corresponds to a sixth sub-pixel. Furthermore, the third sub-pixel is defined as a sub-pixel electrically connected to a data line (hereinafter referred to as a second data line) adjacent to the first data line and the first scan line, the fourth sub-pixel is defined as a sub-pixel electrically connected to the second data line and the second scan line, the fifth sub-pixel is defined as a sub-pixel electrically connected to a third data line and the first scan line, and the sixth sub-pixel is defined as a sub-pixel electrically connected to the third data line and the second scan line. The third sub-pixel grayscale value and the fifth sub-pixel grayscale value may also be regarded as the sub-pixel grayscale value currently detected. The first sub-pixel, the third sub-pixel and the fifth sub-pixel may be arranged adjacent to each other in the X direction. For example, when the first sub-pixel is P(1,1), the third sub-pixel may be P(2,1), and the fifth sub-pixel may be P(3,1). Alternatively, when the first sub-pixel is P(2,2), the third sub-pixel may be P(3,2), and the fifth sub-pixel may be P(4,2) or P(1,2), and so on. In this embodiment, the first sub-pixel, the third sub-pixel and the fifth sub-pixel may correspond to red, blue and green, respectively, that is, the first sub-pixel, the third sub-pixel and the fifth sub-pixel may form a pixel unit, while it is not limited thereto.

Next, step S3 (comparison procedure) is described. In one embodiment, the predetermined condition includes at least one basic condition: the absolute difference value is greater than or equal to a first threshold. In one embodiment, the first threshold may be greater than 0 and smaller than 255 (0<first threshold<255), while it is not limited thereto.

The predetermined condition may only have a basic condition (for example, as long as the basic condition is met, the sub-pixel grayscale value will be adjusted), but the predetermined condition may also include a basic condition and more additional conditions at the same time (that is, the basic condition and the additional conditions must be met at the same time). In one embodiment, the predetermined condition may also include a condition: the second absolute difference value between the third sub-pixel grayscale value and the fourth sub-pixel grayscale value is greater than or equal to the first threshold value (therefore, when the second absolute difference value is greater than or equal to the first threshold value, at least one of the third sub-pixel grayscale value and the fourth sub-pixel grayscale value will be adjusted to he adjusted sub-pixel grayscale value). In one embodiment, the predetermined condition may also include a condition: the second absolute difference value between the third sub-pixel grayscale value and the fourth sub-pixel grayscale value is greater than or equal to the first threshold value (therefore, when the second absolute difference value is greater than or equal to the first threshold value, at least one of the third sub-pixel grayscale value and the fourth sub-pixel grayscale value will be adjusted to the adjusted sub-pixel grayscale value), and the third absolute difference value between the fifth sub-pixel grayscale value and the sixth sub-pixel grayscale value is greater than or equal to the first threshold value (therefore, when the third absolute difference value is greater than or equal to the first threshold value, at least one of the fifth sub-pixel grayscale value and the sixth sub-pixel grayscale value will be adjusted to the adjusted sub-pixel grayscale value), wherein the first sub-pixel, the third sub-pixel and the fifth sub-pixel may, for example, form a pixel unit. For example, the sub-pixels (P(1,1), P(2,1), P(3,1)) in FIG. 2A correspond to red, blue and green, respectively, and may form a pixel unit. In this case, the processing unit 6 may be set so that, when the sub-pixel grayscale values corresponding to the sub-pixels (P(1,1), P(2,1), P(3,1)) are all judged as critical factors, the processing unit 6 will provide an adjustment scheme for adjusting the sub-pixel grayscale values of the sub-pixels (P(1,1), P(2,1), P(3,1)) as the adjusted sub-pixel grayscale values, but it is not limited thereto.

In addition, in one embodiment, the predetermined conditions may further include more additional conditions, for example, in addition to the basic conditions, the absolute difference value between the sub-pixel grayscale values of at least two other sub-pixels must be greater than or equal to the first threshold before the sub-pixel grayscale value is adjusted (for example, one or more sub-pixel grayscale values are adjusted), while it is not limited thereto. In addition, the sub-pixels involved in these predetermined conditions do not have to be adjacent, while it is not limited thereto.

Next, step S4 (adjustment scheme providing procedure) is described. In step S4, the adjustment scheme may include a digital and/or analog adjustment scheme. Regarding the “digital adjustment scheme”, please refer to FIG. 3. In one embodiment, the processing unit 6 itself (the processing unit 6 is a hardware) or a device having the processing unit 6 (the processing unit 6 is a functional module) may store at least one lookup table, or the processing unit 6 may be electrically connected or communicated with an external device storing the lookup table, wherein the lookup table records information on the adjusted sub-pixel grayscale values corresponding to the sub-pixel grayscale values to be adjusted in different situations, in which “different situations” refers to, for example, different absolute difference value, numerical value of different detected sub-pixel grayscale value (for example, the first sub-pixel grayscale value), numerical value of different compared sub-pixel grayscale value (for example, the second sub-pixel grayscale value), or more other changes, while is not limited thereto. Therefore, when a sub-pixel grayscale value needs to be adjusted, the processing unit 6 can use the lookup table to find the adjusted sub-pixel grayscale value corresponding to the sub-pixel grayscale value that needs to be adjusted (for example, the first sub-pixel grayscale value or the second sub-pixel grayscale value), and when all the adjusted sub-pixel grayscale values corresponding to the sub-pixel grayscale values that need to be adjusted are found, the processing unit 6 may convert all the sub-pixel grayscale values that need to be adjusted in the original frame data into the corresponding adjusted sub-pixel grayscale values, so that the original frame data is converted into an adjusted frame data, and the adjusted picture data is used as at least a portion of the output frame data. In one embodiment, the type of the lookup table may include a driving lookup table or a white tracking table, but it is not limited thereto. In one embodiment, the display device 1 may have or be connected to multiple types of lookup tables, wherein the processing unit 6 may switch to select the lookup table to be used, or may also use multiple types of lookup tables at the same time, while it is not limited thereto. In addition, the analog adjustment scheme will be described in the example of FIG. 4.

For more details about the aforementioned “lookup table”, in one embodiment, the type of the lookup table may include, for example, a driving lookup table or a white tracking table. In one embodiment, each type of lookup table may have at least two versions, one of which is used to record the adjustment value (that is, the adjusted sub-pixel grayscale value) corresponding to the sub-pixel grayscale value that needs to be adjusted, and the other version is used to record the value corresponding to the sub-pixel grayscale value that does not need to be adjusted (that is, maintaining the existing grayscale value), while it is not limited thereto. In one embodiment, the lookup table may record, when the sub-pixel grayscale value needs to be adjusted, the data of the adjusted sub-pixel grayscale values corresponding to all possible sub-pixel grayscale values, while it is not limited thereto. In one embodiment, the lookup table may record, when the sub-pixel grayscale values need to be adjusted, the adjusted sub-pixel grayscale values corresponding to a portion of the sub-pixel grayscale values. The processing unit 6 may obtain the adjusted sub-pixel grayscale values corresponding to the unrecorded sub-pixel grayscale values through other methods, such as using interpolation between the adjusted sub-pixel grayscale values corresponding to two recorded sub-pixel grayscale values to obtain the adjusted sub-pixel grayscale value corresponding to the unrecorded sub-pixel grayscale value between the two recorded sub-pixel grayscale values, while it is not limited to this.

Regarding steps S5 and S6, in one embodiment, the processing unit 6 may transmit the output frame data to the timing controller 7, wherein, under the digital adjustment scheme, the output frame data includes the adjusted frame data, so that the timing controller 7 may convert all sub-pixel grayscale values in the adjusted frame data into corresponding multiple voltage values, and drive the data driver 7 to provide data signals (for example, grayscale signals) corresponding to the multiple voltage values to the sub-pixels P on the substrate 2 (shown in FIG. 1), thereby making the sub-pixels P display the required grayscale values, such as the adjusted sub-pixel grayscale values.

It should be noted that the present disclosure may use the comparison between two or more sub-pixel grayscale values as the basis for determination. Next, an actual example of the above steps S2 to S4 will be described, and please refer to FIG. 2A again.

The present disclosure may compare two sub-pixel grayscale values to serve as a basis for determining whether one of the two sub-pixel grayscale values is a critical factor. In one embodiment, the first threshold is set to 241, for example, the first sub-pixel is P(2,2), the second sub-pixel is P(2,1), and the second sub-pixel grayscale value corresponding to the second sub-pixel P(2,1) is 0. In this case, when the first sub-pixel grayscale value corresponding to the first sub-pixel P(2,2) is one of 0 to 240, since the absolute difference values are all smaller than 241, the adjustment scheme provided by the processing unit 6 includes maintaining the first sub-pixel grayscale value and the second sub-pixel grayscale value. In another embodiment, when the first sub-pixel grayscale value corresponding to the first sub-pixel P(2,2) is one of 241 to 255, and the second sub-pixel grayscale value corresponding to the second sub-pixel P(2,1) is 0, since the absolute difference values are all greater than or equal to 241, the adjustment scheme provided by the processing unit 6 includes adjusting at least one of the first sub-pixel grayscale value and/or the second sub-pixel grayscale value to the adjusted sub-pixel grayscale value.

Furthermore, when the first sub-pixel grayscale value is greater than the second sub-pixel grayscale value, and the first sub-pixel grayscale value is to be adjusted to the adjusted sub-pixel grayscale value, the adjusted sub-pixel grayscale value may be smaller than the first sub-pixel grayscale value, that is, the first sub-pixel grayscale value will be lowered, for example, 255 may be adjusted to 244, while it is not limited thereto. Alternatively, when the first sub-pixel grayscale value is greater than the second sub-pixel grayscale value, and the second sub-pixel grayscale value is to be adjusted to the adjusted sub-pixel grayscale value, the adjusted sub-pixel grayscale value may be greater than the second sub-pixel grayscale value, that is, the second sub-pixel grayscale value will be increased, for example, 0 may be adjusted to 8, while it is not limited thereto. Alternatively, when the first sub-pixel grayscale value is greater than the second sub-pixel grayscale value, and both the first sub-pixel grayscale value and the second sub-pixel grayscale value are to be adjusted to the adjusted grayscale value, the second sub-pixel grayscale value may be increased, and the first sub-pixel grayscale value may be decreased.

In addition, in other embodiments, the second sub-pixel may also be P(2,3). However, the present disclosure is not limited thereto. In addition, from the above description, it can be inferred that the first sub-pixel grayscale value is smaller than the second sub-pixel grayscale value.

The present disclosure may also compare more (for example, more than three) sub-pixel grayscale values to serve as a basis for determining whether one of the more sub-pixel grayscale values is a critical factor. In one embodiment, the first threshold is set to 241, the first sub-pixel is P(3,3) and the corresponding first sub-pixel grayscale value is 0, the second sub-pixel is P(3,2), another sub-pixel is P(3,1) and the corresponding another sub-pixel grayscale value is 0. In this case, when the second sub-pixel grayscale value corresponding to the second sub-pixel P(3,2) is one of 0 to 240, since the absolute difference value between the first sub-pixel grayscale value and the second sub-pixel grayscale value is smaller than 241, and the absolute difference value between the another sub-pixel grayscale value and the second sub-pixel grayscale value is also smaller than 241, the adjustment scheme provided by the processing unit 6 includes maintaining the first sub-pixel grayscale value, the second sub-pixel grayscale value and the another sub-pixel grayscale value. On the contrary, when the second sub-pixel grayscale value corresponding to the second sub-pixel P(3,2) is one of 241 to 255, since the absolute difference value between the first sub-pixel grayscale value and the second sub-pixel grayscale value is greater than or equal to 241, and the absolute difference value between the another sub-pixel grayscale value and the second sub-pixel grayscale value is also greater than or equal to 241, the adjustment scheme provided by the processing unit 6 includes adjusting the first sub-pixel grayscale value, the second sub-pixel grayscale value and/or the another sub-pixel grayscale value to the adjusted sub-pixel grayscale value, wherein the grayscale value with a lower value will be increased, and the grayscale value with a higher value will be decreased. In addition, in another embodiment, the second sub-pixel may also be P(3,4) and the another sub-pixel may also be P(3,5). In another embodiment, the second sub-pixel may also be P(3,2) and the another sub-pixel may also be P(3,4).

In another embodiment, the first threshold is set to 241, the first sub-pixel is P(3,3) and the corresponding first sub-pixel grayscale value is 0, the second sub-pixel is P(3,2), the another sub-pixel is P(3,1) and the corresponding another sub-pixel grayscale value is 255. In this case, when the second sub-pixel grayscale value corresponding to the second sub-pixel P(3,2) is one of 0 to 240, since the absolute difference value between the first sub-pixel grayscale value and the second sub-pixel grayscale value is smaller than 241, and the absolute difference value between the another sub-pixel grayscale value and the second sub-pixel grayscale value is also smaller than 241, the adjustment scheme provided by the processing unit 6 includes maintaining the first sub-pixel grayscale value, the second sub-pixel grayscale value and the another sub-pixel grayscale value. However, when the second sub-pixel grayscale value corresponding to the second sub-pixel P(3,2) is one of 241 to 255, although the absolute difference value between the first sub-pixel grayscale value and the second sub-pixel grayscale value is greater than or equal to 241, the absolute difference value between the another sub-pixel grayscale value and the second sub-pixel grayscale value is still smaller than 241, so that the adjustment scheme provided by the processing unit 6 still includes maintaining the first sub-pixel grayscale value, the second sub-pixel grayscale value and the another sub-pixel grayscale value. However, the present disclosure is not limited thereto. In addition, in another embodiment, the second sub-pixel may also be P(3,4) and the another sub-pixel may also be P(3,5). In another embodiment, the second sub-pixel may also be P(3,2) and the another sub-pixel may also be P(3,4).

Accordingly, the driving method of FIG. 3 can be understood.

The driving method of the present disclosure may also have different implementation aspects. FIG. 4 schematically illustrates the steps of the driving method according to another embodiment of the present disclosure, and please refer to FIG. 1 to FIG. 3 for assistance. In the example of FIG. 4, the display device 1 may further include a graphics detection unit 8, and the graphics detection unit 8 may be disposed in the display device 1 or the processing unit 6, or the graphics detection unit 8 may be disposed outside the display device 1 and electrically connected or communicated with the processing unit 6, wherein the graphics detection unit 8 may be used to detect at least a portion of the original frame data, and determine whether at least one sub-pixel grayscale value in the at least a portion needs to be adjusted. In one embodiment, the graphics detection unit 8 is implemented by various feasible methods, such as the aforementioned hardware or functional module method, while it is not limited thereto.

As shown in FIG. 4, steps S11 to S13 may be executed, as shown in steps S1 to S3 of FIG. 3, and thus a detailed description is deemed unnecessary. In addition, step S11′ may also be executed, so that the graphics detection unit 8 receives the original frame data. Then, step S12′ is executed, and the graphics detection unit 8 executes a graphics detection procedure on the original frame data to detect whether the sub-pixel grayscale value in at least a portion of the original frame data needs to be adjusted, and provides the detection result to the processing unit 6. After step S13 or step S12′ is executed, step S14 may be executed, and the processing unit 6 performs an adjustment scheme providing procedure, wherein the adjustment scheme may include a digital form and/or an analog form. Then, step S15 is executed, and the processing unit 6 transmits the output frame data, wherein, when step S14 adopts a digital adjustment scheme, the output frame data may, for example, include the adjusted frame data and, when step S14 adopts an analog adjustment scheme, the output frame data may, for example, include the driving scheme of the data driver 5 and the original frame data. Then, step S16 is executed, and the data driver 5 provides a data signal to each sub-pixel P according to the output frame data.

Regarding step S11′, in one embodiment, the display device 1 may have both the processing unit 6 and the graphics detection unit 8, so steps S11 and S11′ may be performed one by one, or may be performed simultaneously. In another embodiment, the display device 1 may also have only one of the processing unit 6 and the graphics detection unit 8, while it is not limited thereto.

Regarding step S12′, in one embodiment, the graphics detection procedure executed by the graphics detection unit 8 may include graphics detection mechanisms A to C. In one embodiment, the graphics detection mechanism A is: comparing the detected sub-pixel the grayscale value with all the sub-pixel the grayscale values in the original frame data to determine whether the detected sub-pixel grayscale value needs to be adjusted. The graphics detection mechanism B is: comparing the detected sub-pixel grayscale value with all the sub-pixel the grayscale values in a portion of the original frame data to determine whether the detected sub-pixel grayscale value needs to be adjusted. The graphics detection mechanism C is: comparing a certain detected sub-pixel grayscale value with a plurality of sub-pixel grayscale values around it so as to determine whether the detected sub-pixel grayscale value needs to be adjusted (for example, if the first sub-pixel grayscale value is the detected sub-pixel grayscale value, the first sub-pixel grayscale value will be compared with the sub-pixel grayscale values corresponding to the plurality of sub-pixels around the first sub-pixel). Since the graphics detection mechanism A and the graphics detection mechanism B are as described above, a detailed description is deemed unnecessary. In one embodiment, the graphics detection mechanism C may be, for example, to arrange the detected sub-pixel grayscale values and the surrounding sub-pixels grayscale values into an array, perform convolution calculation on the array using a predetermined mask, and then determine whether the detected sub-pixel grayscale value needs to be adjusted based on the result of the convolution calculation, but it is not limited thereto. The details of the graphics detection mechanism C will be described in detail in subsequent paragraphs.

Regarding step S14, the digital adjustment scheme may be generally applied to the description of step S4 in FIG. 3, and thus a detailed description is deemed unnecessary. In one embodiment, the type of the lookup table may be, for example, a driving lookup table or a white tracking table, wherein each type of lookup table may have two versions, one version is used to record the adjustment value corresponding to the sub-pixel grayscale value when it needs to be adjusted (that is, the adjusted sub-pixel grayscale value), and the other version is used to record the numerical value corresponding to the sub-pixel grayscale value when it needs to be adjusted (that is, the original grayscale value), while it is not limited thereto.

Regarding the “analog adjustment scheme”, in one embodiment, the analog adjustment scheme is a driving scheme of the data driver 5, for example, a driving scheme including voltage supply time adjustment, slew rate adjustment, and gamma curve adjustment, etc. In one embodiment, the processing unit 6 itself (the processing unit 6 is a hardware) or a device having the processing unit 6 (the processing unit 6 is a functional module) may store at least one voltage supply time adjustment data table, a slew rate adjustment data table and/or a gamma curve adjustment data table, or the processing unit 6 may be electrically connected or communicated with an external device storing the voltage supply time adjustment data table, the slew rate adjustment data table and/or the gamma curve adjustment data table, wherein the voltage supply time adjustment data table records the supply time of the grayscale signal corresponding to the sub-pixel grayscale value that needs to be adjusted under various variables, the slew rate adjustment data table records the slew rate of the grayscale signal corresponding to the sub-pixel grayscale value that needs to be adjusted under various variables, and the gamma curve adjustment data table records the gamma curve corresponding to the sub-pixel grayscale value that needs to be adjusted under various variables, while it is not limited thereto. Therefore, when a sub-pixel grayscale value needs to be adjusted, the processing unit 6 may use the above data table to find out the information such as the time length of providing the grayscale signal, the slew rate of the grayscale signal and/or the gamma curve corresponding to the sub-pixel grayscale value, and use the information as at least a portion of the output frame data. In one embodiment, each of the above analog data tables may also have two versions, one version is used for the sub-pixel grayscale value that needs to be adjusted, and the other version is used for the sub-pixel grayscale value that does not need to be adjusted, while it is not limited thereto. The details of the above analog adjustment scheme are described below.

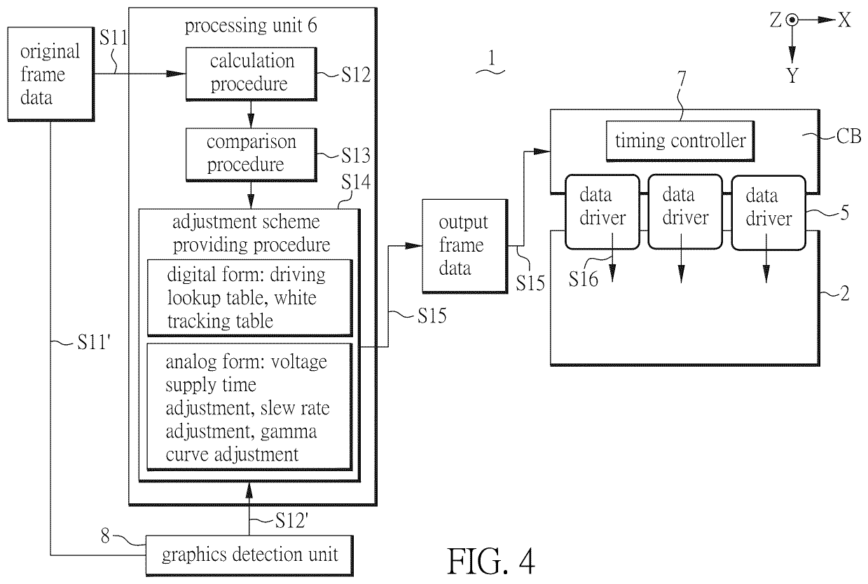

FIG. 5 is a schematic diagram of the voltage supply time adjustment according to an embodiment of the present disclosure, which is used to illustrate the data signal (for example, grayscale signal) provided by the data driver 5 before and after the voltage supply time adjustment, and please refer to FIG. 1 to FIG. 4 at the same time. It should be noted that “voltage supply time adjustment” means that, for each sub-pixel P, the data driver 5 provides the grayscale signal required by the sub-pixel P during a voltage supply period to display the sub-pixel grayscale value in the original frame data and, by adjusting the time point when the data driver 5 supplies the grayscale signal, the length of time that the sub-pixel P actually receives the grayscale signal is shortened or increased, so that the grayscale value displayed by the sub-pixel P may be, for example, the adjusted sub-pixel grayscale value instead of the value in the original frame data. To explain in more detail, the timing controller 7 may periodically transmit a latch signal to the data driver 5 and, during the high voltage period of the latch signal, an impedance element connected to the output end of the data driver 5 will form a high impedance state. At this moment, the signal provided by the data driver 5 will be blocked by the high impedance and may not be transmitted to the sub-pixel P. Therefore, the signal provided by the data driver 5 may only be transmitted to the sub-pixel P when the latch signal changes to a low voltage and the impedance element forms a low impedance state. That is, the data driver 5 supplies the grayscale signal to the sub-pixel P during the voltage supply period between the two high voltage periods of the latch signal. In this case, by extending the period of the high impedance state of the impedance element, the time point at which the data driver 5 actually provides the grayscale signal is delayed, and the period of providing the grayscale signal partially overlaps with the subsequent high voltage period and high impedance state period of the latch signal, so that the length of time that the grayscale signal is actually provided to the sub-pixel P may be shortened, thereby making the grayscale value actually displayed by the sub-pixel P lower than the grayscale value corresponding to the grayscale signal. As shown in FIG. 5, before adjustment, the high impedance period (labeled as Hi-Z) of the data driver 5 overlaps with the high voltage period of the latch signal, and the high voltage period of the grayscale signal does not overlap with the high impedance period and the high voltage period of the latch signal. After adjustment, the high impedance period (labeled as Hi-Z) of the data driver 5 will be extended to overlap with the high voltage period and a portion of the low voltage period of the latch signal. At this moment, the high voltage period of the grayscale signal will overlap with the subsequent high impedance period and the high voltage period of the latch signal. Therefore, the time length of the high voltage period of the grayscale signal is shortened. Therefore, although the grayscale signal provided by the data driver 5 corresponds to the original sub-pixel grayscale value, since the time length of the sub-pixel P actually receiving the grayscale signal is shortened, the grayscale value actually displayed by the sub-pixel P may be smaller than the original grayscale value, as displaying the adjusted sub-pixel grayscale value. From the above, the driving method of increasing the time length of the sub-pixel P actually receiving the grayscale signal may also be inferred that. Thus, when the content of the original frame data is a critical image, the display device 1 may adjust the frame actually displayed to reduce the situation of generating a large amount of power consumption, so as to solve the problems of the prior art.

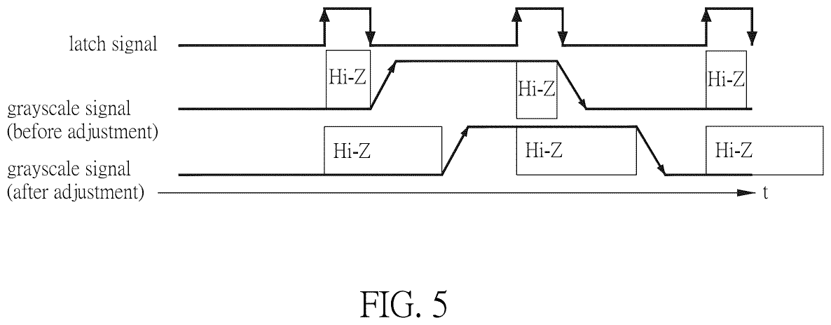

FIG. 6 is a schematic diagram of the slew rate adjustment according to an embodiment of the present disclosure, which is used to illustrate the data signal (for example, grayscale signal) provided by the data driver 5 before and after the slew rate adjustment, and please refer to FIG. 1 to FIG. 4 at the same time. It should be noted that “slew rate adjustment” means that, for each sub-pixel P, the data driver 5 provides a grayscale signal required to make the sub-pixel P display the sub-pixel grayscale value in the original frame data and, by adjusting the waveform of the grayscale signal, the grayscale value actually displayed by the sub-pixel P forms, for example, the adjusted sub-pixel grayscale value instead of the sub-pixel grayscale value in the original frame data. To explain in more detail, the slew rate may correspond to the length of time that a signal rises from a trough to a peak or falls from a peak to a trough. If the length of time that a signal rises from a trough to a peak or falls from a peak to a trough is getting longer, the time that the signal remains at the voltage peak is shorter, and thus the grayscale value actually displayed by the sub-pixel P will be smaller than the grayscale value corresponding to the grayscale signal. Conversely, if the length of time that a signal rises from a trough to a peak or falls from a peak to a trough is getting shorter, the time that the signal remains at the voltage peak is longer, and thus the grayscale value actually displayed by the sub-pixel P may be higher than the grayscale value corresponding to the grayscale signal. As shown in FIG. 6, before adjustment, the time for the grayscale signal to reach the peak (for example, 7 volts (V)) from the trough may be 200 nanoseconds (ns) and, after adjustment, the time for the grayscale signal to reach the peak (for example, 7V) from the trough may be extended to 800 nanoseconds (ns), and the duration of the peak is shorter than that before adjustment, so that the grayscale value actually displayed by the sub-pixel P may be smaller than the grayscale value corresponding to the grayscale signal. Thus, it may be inferred that the grayscale value actually displayed by the sub-pixel P is greater than the grayscale value corresponding to the grayscale signal. Thus, when the content of the original frame data is a critical image, the display device 1 may adjust the frame actually displayed to reduce the situation of generating a large amount of power consumption, so as to solve the problems of the prior art.

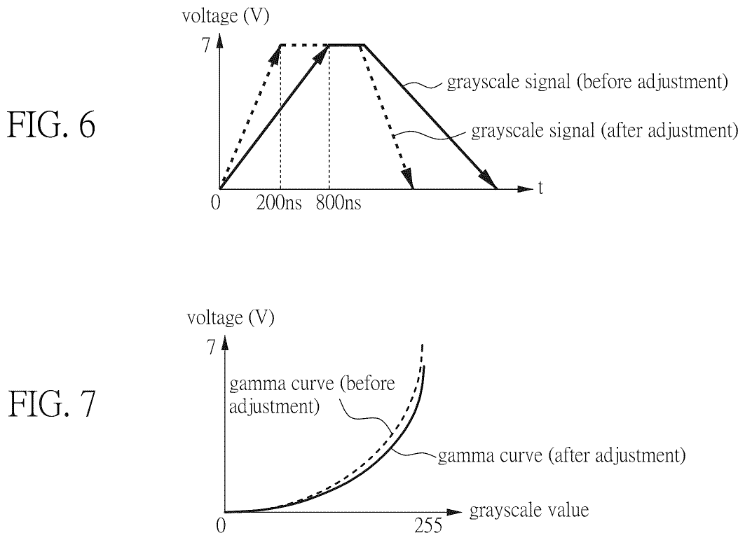

FIG. 7 is a schematic diagram of the gamma curve adjustment according to an embodiment of the present disclosure, which is used to display the gamma curve corresponding to the data signal (for example, grayscale signal) provided by the data driver 5 before and after adjustment, and please refer to FIG. 1 to FIG. 4 at the same time. As shown in FIG. 7, before adjustment, the voltage of the gamma curve corresponding to the maximum grayscale value (255) is 7V and, after adjustment, the voltage of the gamma curve corresponding to the maximum grayscale value (255) is 6V, so that the grayscale value actually displayed by the sub-pixel P may be smaller than the original grayscale value, as displaying the adjusted sub-pixel grayscale value, and vice versa. As a result, when the content of the original frame data is a critical image, the display device 1 may adjust the frame actually displayed to reduce the situation of generating a large amount of power consumption, so as to solve the problems of the prior art.

Accordingly, the analog adjustment scheme in step S14 can be understood. In addition, in one embodiment, the adjustment scheme that the processing unit 6 may select may include at least two of the following schemes: a driving lookup table, a white tracking table, a voltage supply time adjustment, a slew rate adjustment, and a gamma curve adjustment. For each sub-pixel grayscale value, the processing unit 6 may select one or more of the schemes to execute, while it is not limited thereto.

Please refer to FIG. 4 again. Regarding steps S15 and S16, when the processing scheme of the processing unit 6 is in digital form, steps S15 and S16 may be applied to the description of steps S5 and S6 in FIG. 3, and thus a detailed description is deemed unnecessary. When the processing scheme of the processing unit 6 is in analog form, the output frame data output by the processing unit 6 to the timing controller 7 may include information such as the voltage supply time, slew rate and/or gamma curve corresponding to each sub-pixel and the original frame data. The timing controller 7 may drive the data driver 5 according to the output frame data, while it is not limited thereto.

Accordingly, the driving method of FIG. 4 can be understood.

Next, the details of the graphics detection mechanism C of the graphics detection unit 8 will be described. In one embodiment, the detection result of the graphics detection mechanism C may be in a binary form, for example, the graphics detection unit 8 may output a result of 0 or 1, wherein 0 represents that the detected sub-pixel grayscale value does not need to be adjusted, and 1 represents that the detected sub-pixel grayscale value needs to be adjusted, while it is not limited thereto. In one embodiment, the detection result of the graphics detection unit 8 may be in a proportional form, for example, the graphics detection unit 8 may output one of 0, 1, and a value greater than 0 and smaller than 1 (0<value<1), while it is not limited thereto. In the following, an example is taken for explanation.

Assuming that a detected sub-pixel grayscale value will be compared with 9 (columns)×3 (rows) grayscale values surrounding the detected sub-pixel grayscale value, the graphics detection unit 8 may arrange the 27 surrounding sub-pixel grayscale values into a matrix, for example:

$$\begin{matrix}[ 255 & 255 & 255 & 255 & 255 & 255 & 255 & 255 & 255 \\ 0 & 0 & 0 & 0 & 0 & 0 & 0 & 0 & 0 \\ 255 & 255 & 255 & 255 & 255 & 255 & 255 & 255 & 255 ]\end{matrix} .$$

Next, the graphics detection unit 8 may perform convolution calculation on the matrix of the 27 surrounding sub-pixel grayscale values and a predetermined mask, wherein the predetermined mask may be a matrix as follows:

$$\begin{matrix}[ - 1 & - 1 & - 1 & - 1 & - 1 & - 1 & - 1 & - 1 & - 1 \\ 2 & 2 & 2 & 2 & 2 & 2 & 2 & 2 & 2 \\ - 1 & - 1 & - 1 & - 1 & - 1 & - 1 & - 1 & - 1 & - 1 ]\end{matrix} .$$

Next, the graphics detection unit 8 may take the absolute value of the convolution calculation result. For example, when the convolution calculation result is −4590, the graphics detection unit 8 may convert it to 4590.

Next, the graphics detection unit 8 calculates a ratio according to the absolute value of the convolution calculation result, and the ratio may be presented as the following formula:

$$Ratio = ( absolute value of convolution value - TH ) / Weight ,$$

where Ratio is the ratio, TH is a first adjustment parameter, which may be between −255 and 255 (−255≤TH≤255), and Weight is a second adjustment parameter, which may be between 512 and 4590 (512≤Weight≤4590).

In one embodiment, the ratio (Ratio) may be 0 or 1, wherein 0 indicates that the detected sub-pixel grayscale value does not need to be adjusted, and 1 indicates that the detected sub-pixel grayscale value needs to be adjusted. In addition, the ratio may also be a value between 0 and 1.

Furthermore, in one embodiment, the processing unit 6 may perform a calculation based on the ratio (Ratio) calculated by the graphics detection unit 8 and, for example, a driving lookup table, so as to find an adjustment value required for the detected sub-pixel grayscale value. The calculation may be presented as the following formula:

$$adjustment value = C + ( T - C ) \times Ratio ,$$

where C is the original numerical value of the detected sub-pixel grayscale value, and T is an adjusted sub-pixel grayscale value corresponding to the detected sub-pixel grayscale value found using the driving lookup table. For example, assuming that the original numerical value of the detected sub-pixel grayscale value is 255 and T is 240, when the ratio is 0, the adjustment value may be 255, that is, the original numerical value is maintained; when the ratio is 1, the adjustment value may be 240, that is, it is adjusted according to the content of the driving lookup table; when the ratio is 0, the adjustment value may be 247.5, that is, it may be adjusted to be close to the content recorded in the driving lookup table. In this way, a more accurate adjustment value may be provided.

It should be noted that the above calculation is based on an example of a driving lookup table, but in fact it may also be adjusted according to the driving scheme, such as a white tracking table, a voltage supply time adjustment data table, a slew rate adjustment data table or a gamma curve adjustment data table, while it is not limited thereto.

Thus, the driving method of the present disclosure can be understood. By using the driving method provided by the present disclosure, the probability of the display device 1 displaying a critical image may be reduced, thereby reducing the situation of large power consumption.

In one embodiment, the present disclosure may determine whether a product in contention falls within the protection scope of the present disclosure at least by the presence or absence of components, component configurations, mechanism observation and/or operating modes of the product to determine whether it falls within the protection scope of the present disclosure, while it is not limited thereto. In addition, if the protection scope of the present disclosure involves a process flow, the present disclosure may use at least the operating mode of the product in contention to determine whether the product in contention falls within the protection scope of the present disclosure, or may determine whether the product in contention falls within the protection scope of the present disclosure by the algorithm of the product in contention, but it is not limited thereto. In one embodiment, the algorithm of the product in contention may be obtained, for example, by reverse engineering, but it is not limited thereto.

The details or features of the various embodiments of the present disclosure may be mixed and matched as long as they do not violate the spirit of the invention or conflict with each other.

The aforementioned specific embodiments should be construed as merely illustrative, and not limiting the rest of the present disclosure in any way.

1. A driving method for a display device including a plurality of scan lines, a plurality of data lines and a plurality of sub-pixels, each of the plurality of data lines being electrically connected to a portion of the plurality of sub-pixels, and each of the plurality of sub-pixels in the portion being electrically connected to one of the plurality of scan lines, the driving method comprising the steps of:
receiving a frame data including a plurality of sub-pixel grayscale values corresponding to the plurality of sub-pixels;
calculating an absolute difference value between a first sub-pixel grayscale value and a second sub-pixel grayscale value respectively corresponding to a first sub-pixel and a second sub-pixel respectively electrically connected to one of the plurality of data lines and two of the plurality of scan lines; and
comparing the absolute difference value between the first sub-pixel grayscale value and the second sub-pixel grayscale value with a first threshold value and, when the absolute difference value is greater than or equal to the first threshold value, adjusting the sub-pixel grayscale value of at least one of the first sub-pixel and the second sub-pixel,
wherein an absolute difference value between the sub-pixel grayscale values of the first sub-pixel and the second sub-pixel after adjustment is smaller than an absolute difference value between the first sub-pixel grayscale value and the second sub-pixel grayscale value.

2. The driving method as claimed in claim 1, wherein the two of the plurality of scan lines are adjacent to each other.

3. The driving method as claimed in claim 1, wherein the two of the plurality of scan lines are not adjacent to each other.

4. The driving method as claimed in claim 1, wherein the first sub-pixel grayscale value is greater than the second sub-pixel grayscale value, and the first sub-pixel grayscale value is adjusted to an adjusted sub-pixel grayscale value.

5. The driving method as claimed in claim 1, wherein the first sub-pixel grayscale value is greater than the second sub-pixel grayscale value, and the second sub-pixel grayscale value is adjusted to an adjusted sub-pixel grayscale value.

6. The driving method as claimed in claim 1, wherein the step of adjusting the sub-pixel grayscale value of at least one of the first sub-pixel and the second sub-pixel further includes: using a lookup table to find an adjusted sub-pixel grayscale value corresponding to the sub-pixel grayscale value of the at least one of the first sub-pixel and the second sub-pixel.

7. The driving method as claimed in claim 6, wherein the step of adjusting the sub-pixel grayscale value of at least one of the first sub-pixel and the second sub-pixel further includes: using a data driver to provide a grayscale signal to the at least one of the first sub-pixel and the second sub-pixel.

8. The driving method as claimed in claim 7, wherein the grayscale signal corresponds to at least one of the first sub-pixel grayscale value and the second sub-pixel grayscale value, and at least one of voltage supply time, slew rate or corresponding gamma curve of the grayscale signal is adjusted.

9. The driving method as claimed in claim 1, wherein the first sub-pixel grayscale value is greater than the second sub-pixel grayscale value, and an adjusted sub-pixel grayscale value corresponding to the first sub-pixel grayscale value is smaller than the first sub-pixel grayscale value.

10. The driving method as claimed in claim 1, wherein the first sub-pixel grayscale value is greater than the second sub-pixel grayscale value, and an adjusted sub-pixel grayscale value corresponding to the second sub-pixel grayscale value is greater than the second sub-pixel grayscale value.

11. The driving method as claimed in claim 1, wherein the first sub-pixel grayscale value and the second sub-pixel grayscale value are each adjusted to an adjusted sub-pixel grayscale value.

12. The driving method as claimed in claim 11, wherein the first sub-pixel grayscale value is greater than the second sub-pixel grayscale value, and the adjusted sub-pixel grayscale value corresponding to the first sub-pixel grayscale value is smaller than the first sub-pixel grayscale value, and the adjusted sub-pixel grayscale value corresponding to the second sub-pixel grayscale value is greater than the second sub-pixel grayscale value.

13. The driving method as claimed in claim 1, wherein the display device further includes a graphics detection unit for comparing a detected sub-pixel grayscale value in the frame data with a plurality of sub-pixel grayscale values around the detected sub-pixel grayscale value to determine whether the detected sub-pixel grayscale value needs to be adjusted to an adjusted sub-pixel grayscale value.

14. The driving method as claimed in claim 1, further comprising the step of calculating an absolute difference value between a third sub-pixel grayscale value and a fourth sub-pixel grayscale value respectively corresponding to a third sub-pixel and a fourth sub-pixel respectively electrically connected to another one of the plurality of data lines and the two of the plurality of scan lines.

15. The driving method as claimed in claim 14, further includes the step of comparing the absolute difference value between the third sub-pixel grayscale value and the fourth sub-pixel grayscale value with the first threshold value and, when the absolute difference value between the third sub-pixel grayscale value and the fourth sub-pixel grayscale value is greater than or equal to the first threshold value, adjusting at least one of the third sub-pixel grayscale value and the fourth sub-pixel grayscale value to an adjusted sub-pixel grayscale value.

16. The driving method as claimed in claim 15, characterized in that it further comprises the step of calculating an absolute difference value between a fifth sub-pixel grayscale value and a sixth sub-pixel grayscale value respectively corresponding to a fifth sub-pixel and a sixth sub-pixel respectively electrically connected to a further one of the plurality of data lines and the two of the plurality of scan lines.

17. The driving method as claimed in claim 16, further comprising the step of comparing the absolute difference value between the fifth sub-pixel grayscale value and the sixth sub-pixel grayscale value with the first threshold value and, when the absolute difference value between the fifth sub-pixel grayscale value and the sixth sub-pixel grayscale value is greater than or equal to the first threshold value, adjusting at least one of the fifth sub-pixel grayscale value and the sixth sub-pixel grayscale value to an adjusted sub-pixel grayscale value.

18. The driving method as claimed in claim 17, wherein the step of adjusting the sub-pixel grayscale value of at least one of the first sub-pixel and the second sub-pixel further includes: when the absolute difference value between the third sub-pixel grayscale value and the fourth sub-pixel grayscale value is greater than or equal to the first threshold, and when the absolute difference value between the fifth sub-pixel grayscale value and the sixth sub-pixel grayscale value is greater than or equal to the first threshold, adjusting the at least one of the first sub-pixel grayscale value and the second sub-pixel grayscale value, the at least one of the third sub-pixel grayscale value and the fourth sub-pixel grayscale value, and the at least one of the fifth sub-pixel grayscale value and the sixth sub-pixel grayscale value.

19. The driving method as claimed in claim 6, wherein a type of the lookup table includes a driving lookup table or a white tracking table.

20. The driving method as claimed in claim 7, wherein the grayscale signal corresponds to an adjusted sub-pixel grayscale value corresponding to the at least one of the first sub-pixel and the second sub-pixel.
